(19) United States
(12) Patent Application Publication
(10) Pub. No.: US 2025/0371781 A1
(43) Pub. Date: Dec. 4, 2025

(54) Face-Based Auto Exposure for User Enrollment

(71) Applicant: Apple Inc., Cupertino, CA (US)

(72) Inventors: Adam Roben, Swarthmore, PA (US); Cheng-Sheng Hsu, San Jose, CA (US); Christophe Seyve, Saratoga, CA (US)

(21) Appl. No.: 19/094,492

(22) Filed: Mar. 28, 2025

Related U.S. Application Data
(60) Provisional application No. 63/654,418, filed on May 31, 2024.

(51) Int. Cl. G06T 13/40; G02B 27/01; G06V 10/25; G06V 10/80; G06V 40/16; G06V 40/50; H04N 23/73

(52) U.S. Cl. CPC G06T 13/40; G02B 27/0101; G02B 27/017; G06V 10/25; G06V 10/80; G06V 40/161; G06V 40/50; H04N 23/73; G02B 2027/0138

(57) ABSTRACT

Facilitating the capture and processing of enrollment data includes: capturing, e.g., by a head-mounted display (HMD) device operating in a first mode (e.g., a passthrough video mode), first sensor data; performing a first autoexposure (AE) process (e.g., a scene average AE algorithm) on the first sensor data; and then determining that the HMD is operating in a second mode (e.g., a user enrollment mode) that is different than the first mode. Once operating in the second mode, the HMD may proceed by: capturing second sensor data; determining face location data for a subject detected in the second sensor data; performing a second AE process (e.g., a face-weighted AE algorithm) on the second sensor data; and generating a graphical representation for the subject (e.g., a so-called “Persona” or other three-dimensional avatar), based, at least in part, on the second sensor data that has had the second AE process performed on it.

### BACKGROUND

Some devices can generate and present Extended Reality (XR) Environments. An XR environment may include a wholly- or partially-simulated environment that people can sense and/or interact with via an electronic system. In XR, a subset of a person's physical motions, or representations thereof, are tracked, and, in response, one or more characteristics of one or more virtual objects simulated in the XR environment are adjusted in a manner that comports with realistic properties. In some instances, the electronic system may be a headset or other head-mounted display (HMD) device that can be used to “enroll” a user by generating a graphical representation to represent the user virtually, e.g., in an XR environment.

### BRIEF DESCRIPTION OF THE DRAWINGS

FIG. 1 shows an example of a user using an HMD for an enrollment process, in accordance with one or more embodiments.

FIG. 2 shows an example of images generated by an HMD during a user enrollment process, in accordance with some embodiments.

FIG. 3 shows a diagram of a technique for performing improved autoexposure (AE) techniques on sensor data captured by a HMD during a user enrollment process, in accordance with one or more embodiments.

FIG. 4 shows a flowchart of a technique for performing different AE techniques on captured sensor data depending on a mode of operation of an HMD, in accordance with one or more embodiments.

FIG. 5 shows example images captured by an HMD during a user enrollment process with differing AE techniques and the corresponding generated graphical representations of the user, in accordance with some embodiments.

FIG. 6 shows a system diagram of an electronic device, in accordance with one or more embodiments.

FIG. 7 shows an exemplary system for use in various XR technologies.

### DETAILED DESCRIPTION

This disclosure pertains to systems, methods, and computer readable media to facilitate improved image capture for enrollment processes, e.g., processes designed to generate graphical representations (also referred to herein as “Personas”) of the users of head-mounted display (HMD) devices. In particular, this disclosure relates to techniques for using improved autoexposure (AE) processes (e.g., region of interest (ROI)-weighted AE process, wherein the ROI may comprise a user's face) for capturing user enrollment data.

In some XR environments, a user may be represented graphically in the form of a “Persona” (or other form of three-dimensional (3D) avatar) that is configured to mimic the physical characteristics and/or movements of a subject in real time. In order to use a Persona, a user may enroll their particular characteristics using an electronic device, such as an HMD. For example, during an enrollment process, a device may capture sensor data such as image data, depth data, and the like, of a subject from multiple angles and/or while the subject is performing different facial expressions. The sensor data may be applied to an enrollment algorithm to generate a user-specific graphical representation, or Persona, for the user.

The enrollment algorithm may use one or more AE techniques on captured image data which, when captured by the HMD while being operated by a user, can be used to generate user-specific graphical representations. Embodiments described herein are directed to improved techniques for capture the user's enrollment data with better exposure settings. In particular, embodiments described herein use face detection and face tracking data to determine where a user's face is located within the captured sensor data. When a user's face is detected in the captured sensor data during an enrollment mode, the values of the pixels within a detected region around and including the user's face may be used to influence or drive an improved AE algorithm (e.g., a face region-weighted AE algorithm), such that the device can capture higher quality (e.g., better-exposed) sensor data of the user's face, which will lead to the generation of graphical representations (e.g., Personas) of the user that are more tone- and color-accurate, less grainy, and overall better at representing detail in the user's face and surrounding body parts. If a user's face is no longer detected in the captured sensor data during an enrollment mode, the device may return to a more typical (e.g., scene average) AE algorithm, i.e., until a face is again detected in the captured sensor data meeting sufficient face detection criteria.

Thus, according to some embodiments described herein, a head-mounted display (HMD) device is disclosed comprising: one or more processors; a display; one or more image sensors; and one or more computer readable media comprising computer readable code executable by the one or more processors to: capture, by at least a first image sensor of the HMD operating in a first mode (e.g., a passthrough video generation mode), first sensor data; perform a first autoexposure (AE) process (e.g., a scene average AE process) on the first sensor data; determine that the HMD is operating in a second mode (e.g., a user enrollment mode) that is different than the first mode; capture, by at least a first image sensor of the HMD operating in the second mode, second sensor data; determine face location data for a subject detected in the second sensor data (e.g., in terms of a set of face bounding box coordinates); perform a second AE process on the second sensor data that is different than the first AE process, wherein the second AE process is based, at least in part, on the determined face location data (e.g., a face region of interest (ROI)-weighted AE process); and generate a graphical representation (e.g., a Persona) for the subject, based, at least in part, on the second sensor data that has had the second AE process performed on it. According to some such embodiments, e.g., when the first mode comprises a passthrough video generation mode, the HMD may further be configured to display, on a display of the HMD, the first sensor data that has had the first AE process performed on it.

According to other embodiments, the HMD may be further configured to determine whether the user (i.e., subject) that detected in the second sensor data (e.g., during an enrollment process) is within a threshold difference of a target pose. If a determination is made during an enrollment process that a subject's current pose is not within a threshold difference of the target pose, such as if a head of the subject is not within an expected zone or does not have an expected size, then corrective actions may be determined for the subject to undertake in order for their face to be in a better pose for the enrollment process. The corrective action can be conveyed to the subject in a number of ways. For example, a visual prompt indicating a corrective action can be presented on a display facing the user during enrollment. Additionally, or alternatively, the corrective action may be conveyed by way of audio prompt, thereby mitigating the need for visual feedback to the subject to understand the corrective action if a sufficient display is unavailable, or to supplement visual feedback. Further details regarding various types and uses of corrective actions that may be indicated to a user during an avatar enrollment process may be found in the commonly-assigned U.S. patent application bearing Ser. No. 18/674,141 and filed May 24, 2024 (hereinafter “the '141 application), the contents of which are hereby incorporated in their entirety.

According to still other embodiments, the second sensor data comprises sensor data captured from at least a first image sensor and a second image sensor of the HMD, which sensors may, e.g., be driven with the same or different exposure settings, frame rates, gains, etc., as may be needed for a given implementation.

According to yet other embodiments, generating the graphical representation for the subject further comprises: fusing at least two image frames captured as part of the second sensor data (e.g., to form a fused image with a higher dynamic range (i.e., an HDR image) than could be produced by any single captured image frame). As may be understood, HDR images may also lead the generation or higher quality graphical representations of the user than lower dynamic range images.

According to further embodiments, in response to no face location data being detected for the subject in the second sensor data (e.g., for more than a threshold amount of time), a third AE process may be performed on the second sensor data that is different than the second AE process (e.g., wherein the third AE process comprises returning to the first AE process, or using some other scene average-based AE process that does not rely upon the detection of a particular type of ROI). Once face location data is again detected in the second sensor data as meeting any relevant face detection criteria and/or time thresholds, the HMD may again return to performing the second AE process (e.g., the ROI-weighted AE process) on the captured second sensor data.

In the following disclosure, a physical environment refers to a physical world that people can sense and/or interact with without aid of electronic devices. The physical environment may include physical features such as a physical surface or a physical object. For example, the term physical environment may correspond to a physical park that includes physical trees, physical buildings, and physical people. People can directly sense and/or interact with the physical environment such as through sight, touch, hearing, taste, and smell. By contrast, an XR environment refers to a wholly- or partially-simulated environment that people sense and/or interact with via an electronic device. For example, the XR environment may include Augmented Reality (AR) content, Mixed Reality (MR) content, Virtual Reality (VR) content, and/or the like. With an XR system, a subset of a person's physical motions, or representations are tracked, and in response, one or more characteristics of one or more virtual objects simulated in the XR environment, are adjusted in a manner that comports with at least one law of physics. As one example, the XR system may detect head movement and, in response, adjust graphical content and an acoustic field presented to the person in a manner similar to how such views and sounds would change in a physical environment. As another example, the XR system may detect movement of the electronic device presenting the XR environment (e.g., a mobile phone, a tablet, a laptop, or the like) and adjust graphical content and an acoustic field presented to the person in a manner, similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include: head-mountable systems, projection-based systems, heads-up displays (HUD), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light source, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram, or on a physical surface.

In the following description for purposes of explanation, numerous specific details are set forth in order to provide a thorough understanding of the disclosed concepts. As part of this description, some of this disclosure's drawings represent structures and devices in block diagram form in order to avoid obscuring the novel aspects of the disclosed concepts. In the interest of clarity, not all features of an actual implementation may be described. Further, as part of this description, some of this disclosure's drawings may be provided in the form of flowcharts. The boxes in any particular flowchart may be presented in a particular order. It should be understood, however, that the particular sequence of any given flowchart is used only to exemplify one embodiment. In other embodiments, any of the various elements depicted in the flowchart may be deleted, or the illustrated sequence of operations may be performed in a different order, or even concurrently. In addition, other embodiments may include additional steps not depicted as part of the flowchart. Moreover, the language used in this disclosure has been principally selected for readability and instructional purposes and may not have been selected to delineate or circumscribe the inventive subject matter, or resort to the claims being necessary to determine such inventive subject matter. Reference in this disclosure to “one embodiment” or to “an embodiment” means that a particular feature, structure, or characteristic described in connection with the embodiment is included in at least one embodiment of the disclosed subject matter, and multiple references to “one embodiment” or “an embodiment” should not be understood as necessarily all referring to the same embodiment.

It will be appreciated that in the development of any actual implementation (as in any software and/or hardware development project), numerous decisions must be made to achieve a developer's specific goals (e.g., compliance with system- and business-related constraints) and that these goals may vary from one implementation to another. It will also be appreciated that such development efforts might be complex and time-consuming but would, nevertheless, be a routine undertaking for those of ordinary skill in the design and implementation of graphics modeling systems having the benefit of this disclosure.

### Face-Based Auto Exposure for User Enrollment

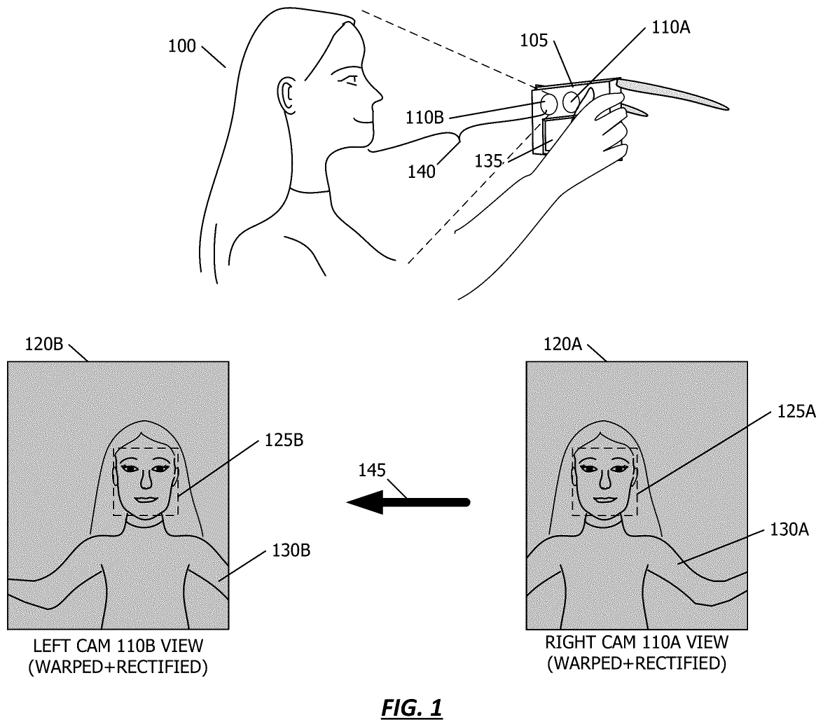

FIG. 1 shows an example of a user 100 (also referred to herein as a “subject”) using an HMD (e.g., headset 105) for an enrollment process. In some embodiments, in order to generate a user-specific graphical representation of the user 100 (e.g., a Persona), the electronic device 105 may capture sensor data from one or more sensors 110A/110B. An enrollment module on the device 105 may obtain sensor data of a user 100 while positioned in different poses and/or while making different facial expressions to generate the data for the user-specific graphical representation. For example, a set or series of poses may be expected for which captured sensor data can be used by the enrollment module to generate a photorealistic graphical representation (e.g., Persona or “avatar”) of the user. Each of these sets of poses may be associated with a range of acceptable locations and/or poses, which will allow the device 100 to capture sensor data that can be used to generate the user-specific graphical representation.

As mentioned above, in some embodiments, the electronic device 105 may be a head mounted display (HMD) device, in which various scene cameras and/or other sensors (e.g., right-side front facing camera 110A and left-side front facing camera 110B, as shown in FIG. 1) that are suitable to capture enrollment data are incorporated into a side of the electronic device that typically faces away from the user when the device is being worn on the user's head. For example, electronic device 105 may include one or more scene cameras (e.g., 110A/110B) or other sensors which, during typical use, are used to capture passthrough data or other sensor data (e.g., depth data, infrared data, Lidar data, etc.) for conveying to the user or for utilizing XR functionality on the device. According to some embodiments, the electronic device 105 may include an external display 135 (in addition to one or more inward-facing displays for displaying generated passthrough video, not shown in FIG. 1), which can present a user prompt conveying to the user how to move the user's face or electronic device 105 to a position and/or orientation at which enrollment data may be captured for use in the generation of a graphical representation of the user. Further, the electronic device 105 may include an internal display, which typically faces toward the user, but, when the device is held in front of the user, e.g., for capture of the aforementioned enrollment data, the internal display may face away from the user. As such, audio prompts can be used to indicate to the user how to move the device 105 to a position and/or orientation at which avatar data can be captured instead of, or in additional to, visual feedback on an external display 135. Further, other forms of feedback may be used to convey to the user whether the relative position and/or orientation of the user to the device satisfies requirements for capturing avatar data, such as haptic feedback or the like.

According to some embodiments, the graphical representations generated based on the sensor data obtained during an enrollment mode of operation may be derived from a set of one or more images and/or other sensor data of the user captured from one or more angles, exposure settings, user poses, and/or while the user is making one or more particular expressions. In some embodiments, visual, audio, and/or other feedback may be provided to indicate to the user how to adjust a relative position and/or orientation of the camera, as well as a position and/or pose of the user, to fit the range of acceptable locations and/or orientations for suitable sensor capture of enrollment data.

In the example of FIG. 1, the user 100 initially holds the electronic device 105 up with cameras 110A/110B pointing toward their face at a comfortable, e.g., arm's length, distance 140, such that the corresponding captured sensor data 120A fully captures the user's face in an expected zone, with an expected size, and/or in an expected pose. In this example, the frame of sensor data 120A depicts a warped and rectified (and, optionally, cropped, downscaled, etc.) representation of the user 130A captured by the right-side front facing camera 110A, such that the face of the user is (represented by the detected face box 125A) is within a threshold difference of a target pose for enrollment (e.g., including the entire face of the subject user 100, within a particular expected zone of the captured frame, and/or the face box having dimensions within an acceptable range).

In some embodiments, rather than separately and independently detecting the user's face location 125B within the representation of the user 130B in the warped and rectified representation of the left-side front facing camera's sensor data 120B, the enrollment process may simply perform a translation operation 145 to derive the likely coordinates of the user's face location 125B, e.g., using trigonometric principles and based on a combination of: the coordinates of the detected face box 125A; the current distance 140 of the user 100 away from the device 105; and the current pose of the user 100. As will be understood, the use of right-side camera sensor data 120A to mathematically derive the predicted coordinates of the face box 125B in the left-side camera sensor data 120B (i.e., as opposed to separately detecting the user's face location in sensor data 120B) is merely an exemplary implementation that may be practiced if increased efficiencies are desired, and does not preclude the use of an implementation that may, e.g., independently detect and locate the face of the user in more than one camera's captured sensor data.

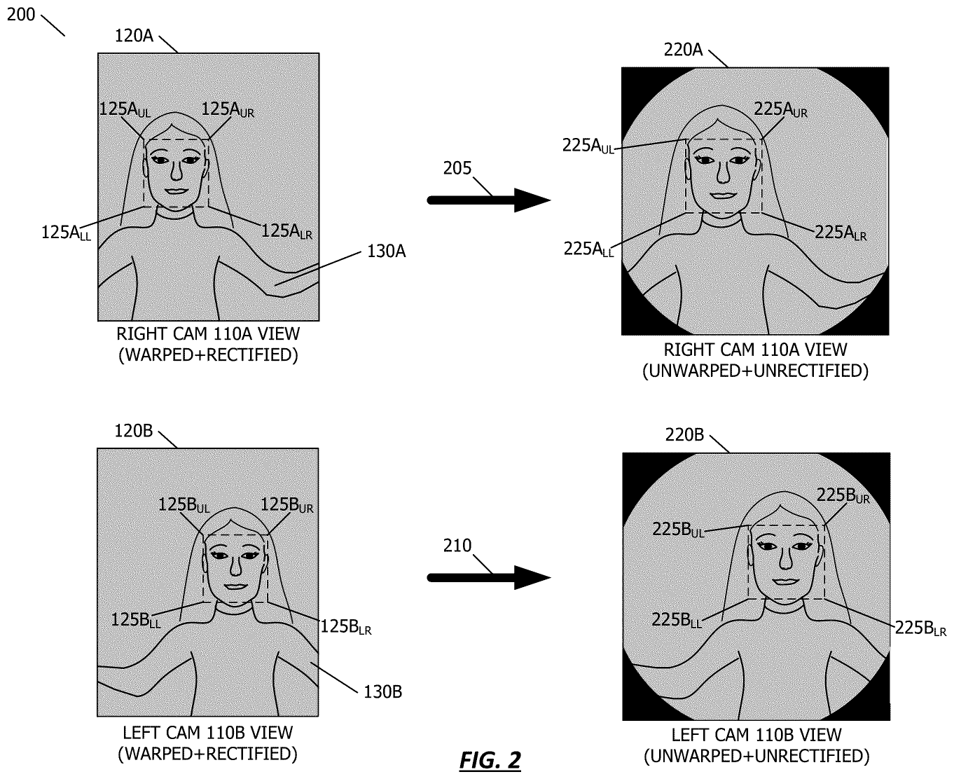

FIG. 2 depicts an example 200 of images 220A/220B generated by an HMD during a user enrollment process, in accordance with some embodiments. In some such embodiments, the right-side front facing camera's sensor data 120A and left-side front facing camera's sensor data 120B introduced with respect to FIG. 1, above, may represent image data that has been warped, rectified, cropped, and/or downscaled from its original form as captured by the respective cameras' image sensors (which may, e.g., be fisheye or other wide field of view (FOV) cameras).

Thus, according to some such embodiments, when an image frame(s) of the captured sensor data are identified as being suitable for use in an enrollment process to generate a graphical representation of a user, any processing applied to the sensor data 120 after being initially captured by the image sensor (also sometimes referred to as the “RAW” sensor data) may essentially be reversed (e.g., by performing a re-warping, un-rectifying, un-cropping, and/or un-scaling, etc., operation on the sensor data 120) in order to produce a set of coordinates 225 representing the face bounding boxes in original sensor space 220, as represented in the right/left sensor image frame pair 220A/220B. (In some such embodiments, the unscaled RAW sensor data may be of a much higher resolution than the sensor data 120 described above and, thus, it may be more efficient to only perform the translations 205/210 into image sensor space and/or to save RAW sensor image frames 220A/220B for use in the enrollment and graphical representation generation process once it has been detected, e.g., from an analysis of processed sensor data 120, that the user is at a location and/or in a pose that will be suitable for use in the generation of a high-quality graphical representation of the user.)

In other embodiments, RAW images 220A/220B may also be captured continuously, i.e., alongside corresponding images 120A/120B. In such embodiments, the translations 205/210 to identify the location of the face boxes 225A/225B in image sensor space may also be performed continuously as the image sensor data is captured (i.e., rather than waiting until an image 120A is explicitly identified as being suitable for use in an enrollment process to perform translation operations 205/210). Recall that, as mentioned with reference to FIG. 1, in some embodiments, e.g., in order to perform the AE operations described herein more efficiently, a face of the subject for a given image frame captured at time, t, may only be located in a single image 120A, with appropriate translations 145, 205, and 210 being used to estimate the analogous locations of the subject's face in images 120B, 220A, and 220B, respectively, at the time, t.

As may now be appreciated, after reversing, e.g., by a translation process(es) 205, any RAW image sensor data processing that resulted in the current coordinates of detected face box 125A (represented by an upper-left point 125A_{UL}, an upper-right point 125A_{UR}, a lower-left point 125A_{LL}, and a lower-right point 12A5_{LR}), the enrollment process may be able to identify face box 225A in image sensor space data 220A (represented by an upper-left point 225A_{UL}, an upper-right point 225A_{UR}, a lower-left point 225A_{LL}, and a lower-right point 225A_{LR}). As may now be understood, the shape of face box 225A may not necessarily be perfectly rectangular in sensor space, and may instead be trapezoidal or otherwise distorted, depending on the reverse sensor data processing performed on the image data at 205.

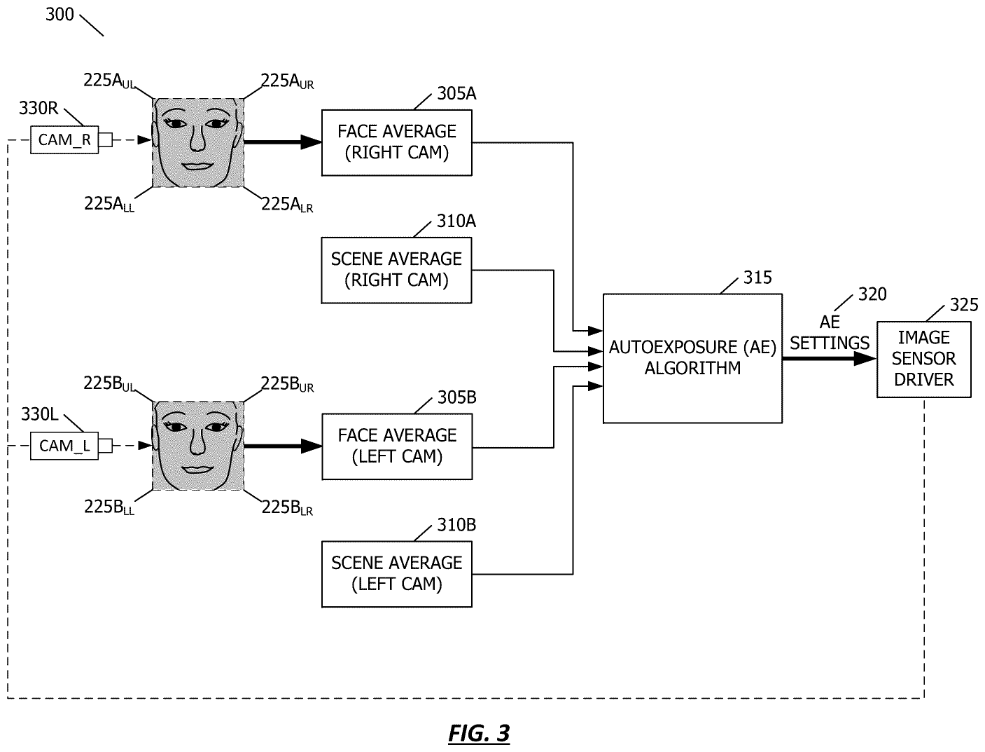

An analogous image processing reversal process may also be performed on sensor data from any other cameras whose output will be used in the generation of the graphical representation of the user during the enrollment process. For example, after reversing by a translation process 210 any processing on the coordinates of detected face box 125B (represented by an upper-left point 125B_{UL}, an upper-right point 125B_{UR}, a lower-left point 125B_{LL}, and a lower-right point 125B_{LR}), the enrollment process may also be able to identify face box 225B in image sensor space data 220B (represented by an upper-left point 225B_{UL}, an upper-right point 225B_{UR}, a lower-left point 225B_{LL}, and a lower-right point 225B_{LR}). As will be explained in further detail with respect to FIG. 3, the pixel data within the identified face bounding boxes in image sensor space (i.e., 225A and 225B) may be utilized as part of an improved (e.g., face-based or otherwise ROI-based) AE technique when capturing the image data during a user enrollment process that is to be used in the generation of a graphical representation of a user, such as a Persona, 3D avatar, or the like.

FIG. 3 depicts a diagram 300 of a technique for performing improved autoexposure (AE) techniques on sensor data captured by a HMD during a user enrollment process, in accordance with one or more embodiments. First, the pixel data within the aforementioned identified face bounding boxes from FIG. 2 (i.e., face bounding boxes 225A and 225B in image sensor space, represented by coordinates 225A_{UL}/225A_{UR}/225A_{LL}/225A_{LR} and coordinates 225B_{UL}/225B_{UR}/225B_{LL}/225B_{LR}, respectively) may be used to generate an AE statistic based on the respective face representations. For example, the pixel data from within face bounding box 225A may be used at block 305A to compute a “face average” statistic for the right-side front facing camera 110A. Similarly, the pixel data from within face bounding box 225B may be used at block 305B to compute a “face average” statistic for the left-side front facing camera 110B.

According to some embodiments, additional AE statistics (e.g., non-face-based or face-weighted statistics) may be determined for each of the image sensors contributing pixel sensor data to the enrollment process. For example, a scene average AE statistic (e.g., a center-weighted scene average, a flat scene average, or any other desired scene averaging algorithm) may be computed at block 310A to compute a “scene average” statistic for the right-side front facing camera 110A. Similarly, a scene average AE statistic (e.g., a center-weighted scene average, a flat scene average, or any other desired scene averaging algorithm) may be computed at block 310B to compute a “scene average” statistic for the left-side front facing camera 110B.

Next, the desired set of computed AE statistics (e.g., 305A/310A/305B/310B in the example of FIG. 3) may be combined by AE algorithm 315. In some examples, e.g., when a face of a user is detected within a threshold difference of a target pose during an enrollment mode, the AE algorithm may use an improved (e.g., face-weighted) AE algorithm to compute the AE settings 320 used to drive the image sensor driver 325 for the next image(s) to be captured by the respective cameras' image sensors (e.g., as shown by the dashed line arrow feeding back updated AE setting values to right-side front facing camera 330R and left-side front facing camera 330L in FIG. 3).

According to some embodiments, the improved AE algorithm employed at 315 may be based fully on the face average statistics computed at 305A/305B, fully on the scene average statistics computed at 310A/310B, or upon a combination thereof. For example, according to some embodiments, it may be preferable to compute the setting of new AE settings 320 based on a blended average that is based 90% on the face average statistics computed at 305A/305B and 10% on the scene average statistics computed at 310A/310B. Of course, other blending and weighting schemes are also possible, e.g., based on the confidence, size, and/or clarity of the face detected in the captured sensor data, or the like.

According to some embodiments, the face average statistics computed for the various cameras (e.g., 305A/305B) themselves may be given an equal weight to each other in the AE algorithm employed at 315 (i.e., weighting the left camera's data the equally to the right camera's data). According to other embodiments, if so desired, the face average statistics (and/or scene average statistics) computed for the various cameras may be given unequal weights to each other in the AE algorithm employed at 315. For example, if the statistics computed by a particular image sensor are likely to be more reliable, of a higher quality, and/or cover more of the environment around the device than the statistics computed by another image sensor of the device, then such image sensor may be given a higher weight in the AE settings computations by the AE algorithm 315. Conversely, if one image sensor of the device was partially or wholly occluded during the capture of its image sensor data, then such image sensor may be given a lower weight in the AE settings computations by the AE algorithm 315, and so forth.

While most of the AE statistics described above comprise some type of average-based AE statistic, this is merely illustrative, and the use of an average-based statistic is not strictly necessary. For example, in captured images where pixel saturation (i.e., clipping) has occurred (e.g., in specular reflections on the surface of a subject's skin), which specular reflections may bring additional white or other “false” colors onto the subject's face, additional logic may be included in the image pixel histograms (e.g., histograms used as input to the computation of statistics 305 and/or 310), such that clipped pixels in the histogram channels (e.g., in the face bounding box and/or other areas of the scene) may be excluded from (or deemphasized in) the computation of the relevant scene AE statistics 305/310. Other embodiments may involve adjusting the AE settings of one or more cameras 330 downward (e.g., up to some predefined maximum allowed exposure decrease amount), e.g., until less than a threshold number of image pixels are clipped/saturated. Still other embodiments may involve training graphical representation generation algorithms to specifically exclude (or deemphasize) clipped/saturated pixels from the captured sensor data that is ultimately used when generating the graphical representations of subjects.

As will be appreciated, the AE algorithm 315 may also consider any number of other relevant input factors, such as output from an IMU(s) associated with the HMD (which may be indicative of amounts of expected motion blurring), light flicker estimates, motion blur estimates, user-specific tuning values, etc. when computing the updated AE settings 320, based on the needs of a given implementation.

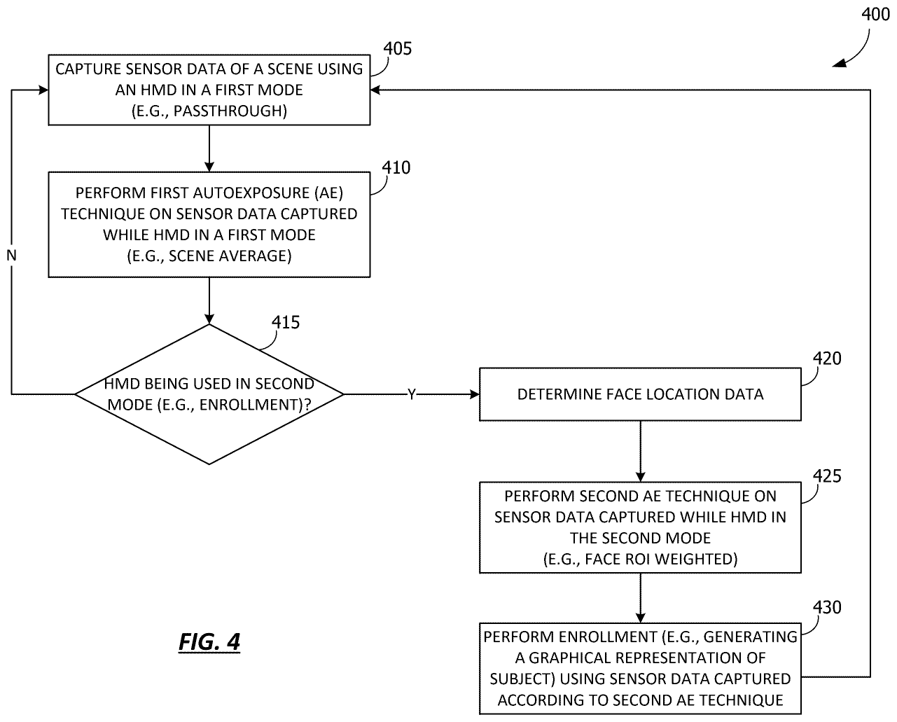

FIG. 4 depicts a flowchart of a technique for performing different AE techniques on captured sensor data depending on a mode of operation of an HMD. In particular, the flowchart presented in FIG. 4 depicts an example technique for performing AE in multiple operational modes of an HMD, e.g., a passthrough mode and a user enrollment mode, such that higher quality facial enrollment data can be captured in a wider variety of lighting conditions and environments. For purposes of explanation, the following steps will be described as being performed by particular components. However, it should be understood that the various actions may be performed by alternate components. In addition, the various actions may be performed in a different order. Further, some actions may be performed simultaneously, some may not be required, or others may be added.

The flowchart 400 begins at block 405, where sensor data of a scene is captured using an HMD in a first mode, e.g., a “passthrough” video generation mode, wherein images of a scene around the HMD are captured by one or more outward-facing cameras, processed according to desired techniques, and then displayed (at least in part) on a display of the HMD that is visible to the user (which display may also, e.g., be enhanced with other virtual or augmented content). Detection of the HMD operating in a passthrough video generation mode may involve the use of one or more ambient light sensors (ALS) of the HMD, inward-facing cameras of the HMD, pressure sensors, or the like. (Note: The term “inward-facing cameras,” as used herein, refers to cameras of an HMD that are facing towards a user's face when the user wearing the HMD, while the term “outward-facing cameras,” as used herein, refers to cameras of an HMD that are facing away from a user's face when the user wearing the HMD.)

The flowchart 400 proceeds to block 410, wherein the HMD may perform a first AE technique (e.g., a scene average AE technique) on the sensor data captured while the HMD is operating the first mode. According to some implementations, the HMD may perform particular image processing techniques tailored to the passthrough video generation use case (e.g., decreasing the exposure stop, increasing gain, performing highlight recovery, noise reduction, etc.) that may not be optimal for other operational modes.

The flowchart 400 proceeds to block 415, wherein it is determined whether the HMD is being operated in a second mode that is different than the first mode. In this example, the second mode will be a user enrollment mode (as has been detailed above), although it is to be understood that the first mode and second modes may represent any HMD operational modes where different and/or customized AE techniques may be beneficially employed based on the use case of the particular operational mode. As mentioned above, detection of the HMD operating in the second mode (e.g., a user enrollment mode) may also involve the use of one or more ambient light sensors (ALS) of the HMD, inward- or outward-facing cameras of the HMD, pressure sensors, or the like, which may indicate that the user has taken the HMD off of their head, and is now pointing outward-facing cameras of the HMD at themself.

If, at block 415, it is determined that the HMD is not being operated in the second mode yet (i.e., “N” at block 415), the process may simply return to block 405 and continue to operate in the first mode and perform the first AE technique on the sensor captured data. If, instead, at block 415, it is determined that the HMD is being operated in the second mode yet (i.e., “Y” at block 415), the process may proceed to block 420 to determine the face location data (e.g., in terms of coordinates of a bounding box for the face in sensor space, as described above with reference to FIG. 2). Determination of the face location within the captured sensor data may further be based on one or more of: color information, face detection algorithms, skin tone segmentation algorithms, neural networks, object classification networks, corresponding scene depth data, or the like.

As described in various examples above, in some embodiments, the sensor data may be captured in conjunction with a face detection and tracking functionality of the HMD enabled. Thus, in some embodiments, when the HMD is operating in the second mode, once it has been confirmed that the current pose of a captured subject detected in the sensor data is within a threshold difference of a target pose (e.g., the user's face is within a desired zone of the sensor data and has at least a desired size, etc.), the flowchart 400 may proceed to block 425 to perform a second AE technique on the sensor data captured while the HMD is operating in the second mode. For example, in some embodiments, the second AE technique may comprise an ROI-weighted (e.g., face-weighted) scene AE algorithm that provides for better (e.g., brighter) exposure of a subject's facial region, e.g., as described above with reference to FIG. 3.

As mentioned above, according to some embodiments, the sensor data captured while the HMD is operating in the second mode may comprise sensor data captured from at least a first image sensor and a second image sensor of the HMD, which sensors may, e.g., be driven with the same or different exposure settings, frame rates, gains, etc., as may be needed for a given implementation. For example, one image sensor may be driven at an EVO exposure setting, while another image sensor may be driven at an EV-1 exposure setting. As another example, one image sensor may be driven at frame rate of 90 Hz, while another image sensor may be driven at a frame rate of 60 Hz, e.g., depending on the environmental conditions around the HMD, the individual exposure settings of each image sensor, etc. In still other embodiments, only a single image senor of the HMD may be used to obtain the images of the subject's face and drive the AE algorithms in the first and second modes of operation. Furthermore, the exposure settings, auto white balance (AWB) algorithms, and/or frame rates that are available (and/or used by default) may be different for the first and second modes of operation, since such modes have different goals and uses. In some embodiments, an AWB algorithm that is designed to give a more accurate rendition of skin/clothing tones may be used when the HMD is operating in an enrollment mode, as opposed to when it is operating in a passthrough video generation mode. As one example of an improved AWB algorithm, the clipping point on one or more of the red (R), green (G), or blue (B) color channels of the captured image sensor data may be independently controlled, such that the number of clipped pixels in a given channel(s) is reduced or eliminated before calculating a white point value for the captured image sensor data.

The flowchart 400 then proceeds to block 430, where the HMD completes the enrollment process, e.g., by generating a graphical representation of the subject (such as a Persona or other 3D-style avatar) using the sensor data captured and processed according to the second AE technique. As mentioned above, although largely described in conjunction with FIGS. 2 and 3 above as using singe image frames from each applicable device camera, according to some embodiments, generating the graphical representation for the subject may further comprise fusing at least two image frames captured as part of the second sensor data (e.g., to form a fused image with a higher dynamic range than could be produced by any single captured image frame). As may be understood, HDR images may also lead the generation or higher quality graphical representations of the user than lower dynamic range images.

If so desired, once the enrollment data is captured, a satisfactory graphical representation of the user is generated, and/or when the enrollment process is completed, the flowchart 400 may return to block 405, wherein the HMD may return to operating in the first operational mode, e.g., a passthrough video generation mode (or any other desired operational mode, based on the needs of a given implementation).

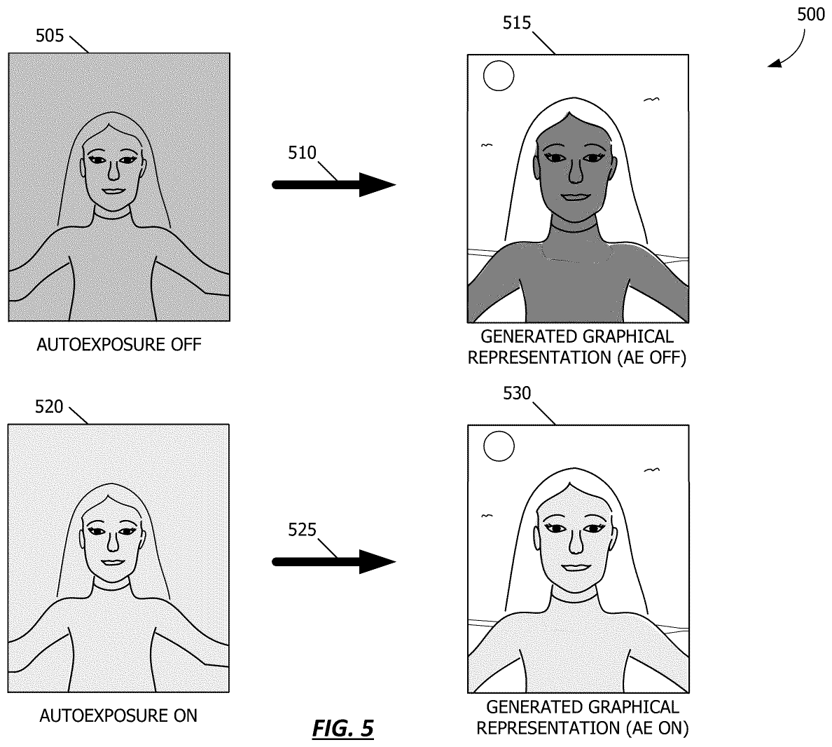

FIG. 5 shows example images 500 captured by an HMD during a user enrollment process with differing AE techniques and the corresponding generated graphical representations of the user, in accordance with some embodiments. As may now be appreciated, image 505 represents an image of the user captured by an outward-facing camera(s) of an HMD-either without any AE technique applied or without a specific face-based AE technique (such as those described herein) applied to the captured sensor data. The graphical representation generation process 510 for image 505 then results in generated graphical representation 515 that is darker, less tone- and color-accurate, grainier, and/or poorer at representing detail in the user's face and surrounding body parts. By contrast, image 520 represents an image of the user captured by an outward-facing camera(s) of an HMD—with an improved (e.g., face-based) AE technique (such as those described herein) applied to the captured sensor data. The graphical representation generation process 525 for image 520 then results in generated graphical representation 530 that is lighter, more tone- and color-accurate, less grainy, and/or better at representing detail in the user's face and surrounding body parts.

### Exemplary Electronic Devices

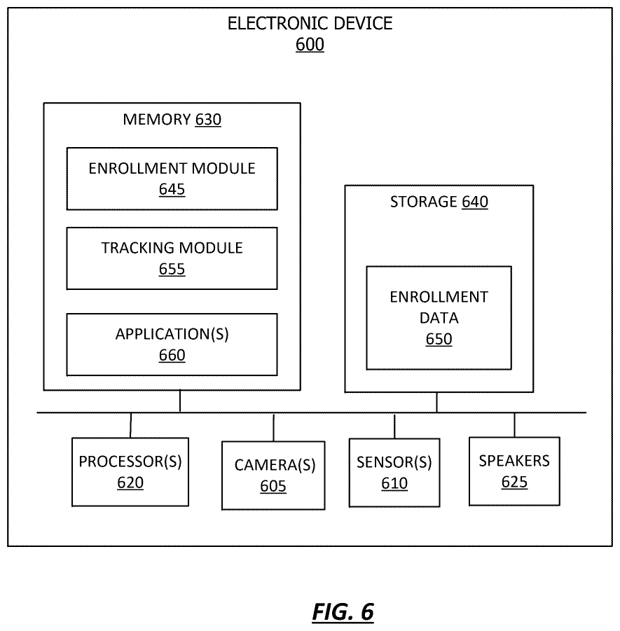

Referring to FIG. 6, a simplified block diagram of an electronic device 600 is depicted. Electronic device 600 may be part of a multifunctional device, such as a mobile phone, tablet computer, personal digital assistant, portable music/video player, wearable device, head-mounted device, projection-based systems, base station, laptop computer, desktop computer, network device, or any other electronic systems such as those described herein. Electronic device 600 may include one or more additional devices within which the various functionality may be contained, or across which the various functionality may be distributed, such as via server devices, base stations, accessory devices, etc. Illustrative networks include, but are not limited to, a local network such as a universal serial bus (USB) network, an organization's local area network, and a wide area network such as the Internet. According to one or more embodiments, electronic device 600 is utilized to interact with a user interface of an application(s) 660. It should be understood that the various components and functionality within electronic device 600 may be differently distributed across the modules or components, or even across additional devices.

Electronic device 600 may include one or more processors 620, such as a central processing unit (CPU) or graphics processing unit (GPU). Electronic device 600 may also include a memory 630. Memory 630 may include one or more different types of memory, which may be used for performing device functions in conjunction with processors 620. For example, memory 630 may include cache, ROM, RAM, or any kind of transitory or non-transitory computer-readable storage medium capable of storing computer-readable code. Memory 630 may store various programming modules for execution by processors 620, including enrollment module 645 (e.g., for performing the various improved face-based AE enrollment processes described herein), tracking module 655, and other various applications 660. Electronic device 600 may also include storage 640. Storage 640 may include one more non-transitory computer-readable mediums, including, for example, magnetic disks (fixed, floppy, and removable) and tape, optical media such as CD-ROMs and digital video disks (DVDs), and semiconductor memory devices such as Electrically Programmable Read-Only Memory (EPROM) and Electrically Erasable Programmable Read-Only Memory (EEPROM). Storage 640 may be configured to store enrollment data 650. Enrollment data 650 may include data related to a particular user account for use by the electronic device to generate user-specific graphical representations that mimic a particular user's characteristics and/or movement. Electronic device 600 may additionally include a network interface from which the electronic device 600 can communicate across a network, and speakers 625, which can be used to present a user prompt for enrollment.

Electronic device 600 may also include one or more cameras 605 or other sensor(s) 610, such as a depth sensor, from which depth of a scene may be determined, such as a region in front of the electronic device, or behind the electronic device, such as a user wearing a headset. In one or more embodiments, each of the one or more cameras 605 may be a traditional RGB camera or a depth camera. Further, camera(s) 605 may include a stereo camera or other multicamera system. In addition, electronic device 600 may include other sensors which may collect sensor data for tracking user movements, such as a depth camera, infrared sensors, orientation sensors, one or more gyroscopes, accelerometers, and the like.

Although electronic device 600 is depicted as comprising the numerous components described above, in one or more embodiments, the various components may be distributed across multiple devices. Accordingly, although certain calls and transmissions are described herein with respect to the particular systems as depicted, in one or more embodiments, the various calls and transmissions may be made differently directed based on the differently distributed functionality. Further, additional components may be used, and some combination of the functionality of any of the components may be combined.

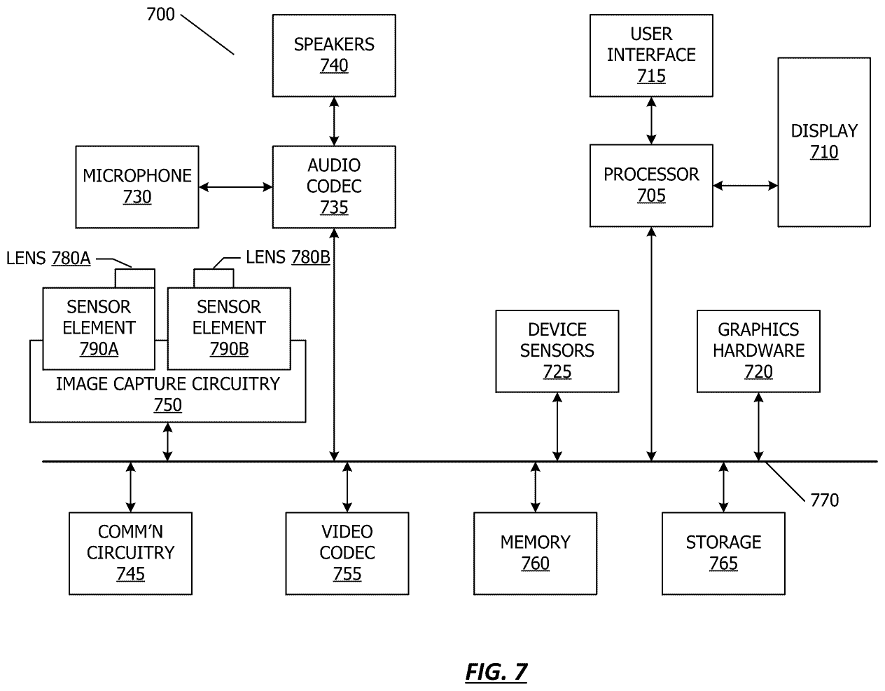

Referring now to FIG. 7, a simplified functional block diagram of illustrative multifunction electronic device 700 is shown according to one embodiment. Each of electronic devices may be a multifunctional electronic device or may have some or all of the described components of a multifunctional electronic device described herein. Multifunction electronic device 700 may include a processor 705, display 710, user interface 715, graphics hardware 720, device sensors 725 (e.g., proximity sensor/ambient light sensor, accelerometer and/or gyroscope), microphone 730, audio codec(s) 735, speaker(s) 740, communications circuitry 745, digital image capture circuitry 750 (e.g., including camera system), video codec(s) 755 (e.g., in support of digital image capture unit), memory 760, storage device 765, and communications bus 770. Multifunction electronic device 700 may be, for example, a digital camera or a personal electronic device such as a personal digital assistant (PDA), personal music player, mobile telephone, or a tablet computer.

Processor 705 may execute instructions necessary to carry out or control the operation of many functions performed by device 700 (e.g., such as the generation and/or processing of images as disclosed herein). Processor 705 may, for instance, drive display 710 and receive user input from user interface 715. User interface 715 may allow a user to interact with device 700. For example, user interface 715 can take a variety of forms, such as a button, keypad, dial, a click wheel, keyboard, display screen, touch screen, gaze, and/or gestures. Processor 705 may also, for example, be a system-on-chip such as those found in mobile devices and include a dedicated GPU. Processor 705 may be based on reduced an instruction-set computer (RISC), a complex instruction-set computer (CISC), architectures, or any other suitable architecture and may include one or more processing cores. Graphics hardware 720 may be special purpose computational hardware for processing graphics and/or assisting processor 705 to process graphics information. In one embodiment, graphics hardware 720 may include a programmable GPU.

Image capture circuitry 750 may include two (or more) lens assemblies 780A and 780B, where each lens assembly may have a separate focal length. For example, lens assembly 780A may have a short focal length relative to the focal length of lens assembly 780B. Each lens assembly may have a separate associated sensor element 790. Alternatively, two or more lens assemblies may share a common sensor element. Image capture circuitry 750 may capture still and/or video images. Output from image capture circuitry 750 may be processed by video codec(s) 755, processor 705, graphics hardware 720, and/or a dedicated image processing unit or pipeline incorporated within circuitry 750. Images so captured may be stored in memory 760 and/or storage 765.

Sensor and camera circuitry 750 may capture still and video images that may be processed in accordance with this disclosure, at least in part, by video codec(s) 755, processor 705, graphics hardware 720, and/or a dedicated image processing unit incorporated within circuitry 750. Images so captured may be stored in memory 760 and/or storage 765. Memory 760 may include one or more different types of media used by processor 705 and graphics hardware 720 to perform device functions. For example, memory 760 may include memory cache, read-only memory (ROM), and/or random access memory (RAM). Storage 765 may store media (e.g., audio, image and video files), computer program instructions or software, preference information, device profile information, and any other suitable data. Storage 765 may include one more non-transitory computer-readable storage mediums including, for example, magnetic disks (fixed, floppy, and removable) and tape, optical media such as CD-ROMs and DVDs, and semiconductor memory devices such as EPROM and EEPROM. Memory 760 and storage 765 may be used to tangibly retain computer program instructions, or code organized into one or more modules and written in any desired computer programming language. When executed by, for example, processor 705, such computer program code may implement one or more of the methods described herein.

### Additional Comments

Various processes defined herein consider the option of obtaining and utilizing a user's identifying information. For example, such personal information may be utilized in order to track motion by the user. However, to the extent such personal information is collected, such information should be obtained with the user's informed consent, and the user should have knowledge of and control over the use of their personal information.

Personal information will be utilized by appropriate parties only for legitimate and reasonable purposes. Those parties utilizing such information will adhere to privacy policies and practices that are at least in accordance with appropriate laws and regulations. In addition, such policies are to be well established and in compliance with or above governmental/industry standards. Moreover, these parties will not distribute, sell, or otherwise share such information outside of any reasonable and legitimate purposes.

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health-related applications, data de-identification can be used to protect a user's privacy. De-identification may be facilitated, when appropriate, by removing specific identifiers (e.g., date of birth), controlling the amount or specificity of data stored (e.g., collecting location data at city level rather than at an address level), controlling how data is stored (e.g., aggregating data across users), and/or other methods.

It is to be understood that the above description is intended to be illustrative and not restrictive. The material has been presented to enable any person skilled in the art to make and use the disclosed subject matter as claimed and is provided in the context of particular embodiments, variations of which will be readily apparent to those skilled in the art (e.g., some of the disclosed embodiments may be used in combination with each other). Accordingly, the specific arrangement of steps or actions shown in FIGS. 1-5, or the arrangement of elements shown in FIGS. 1 and 6-7, should not be construed as limiting the scope of the disclosed subject matter. The scope of the invention, therefore, should be determined with reference to the appended claims, along with the full scope of equivalents to which such claims are entitled. In the appended claims, the terms “including” and “in which” are used as the plain-English equivalents of the respective terms “comprising” and “wherein.”

1. A method comprising:
capturing, by a head-mounted display (HMD) device operating in a first mode, first sensor data;
performing a first autoexposure (AE) process on the first sensor data;
determining that the HMD is operating in a second mode that is different than the first mode;
capturing, by the HMD operating in the second mode, second sensor data;
determining face location data for a subject detected in the second sensor data;
performing a second AE process on the second sensor data that is different than the first AE process, wherein the second AE process is based, at least in part, on the determined face location data; and
generating a graphical representation for the subject, based, at least in part, on the second sensor data that has had the second AE process performed on it.

2. The method of claim 1, wherein the first mode comprises a passthrough video generation mode.

3. The method of claim 1, wherein the first AE process comprises a scene average AE process.

4. The method of claim 1, further comprising:
displaying, on a display of the HMD, the first sensor data that has had the first AE process performed on it.

5. The method of claim 1, wherein the second mode comprises an enrollment mode.

6. The method of claim 1, wherein determining that the HMD is operating in a second mode that is different than the first mode comprises:
determining that the subject detected in the second sensor data is within a threshold difference of a target pose.

7. The method of claim 6, wherein determining that the subject detected in the second sensor data is within a threshold difference of a target pose comprises at least one of:
determining that a head of the subject is within an expected zone; or
determining that the head of the subject has an expected size.

8. The method of claim 1, wherein the second AE process comprises a region of interest (ROI)-weighted AE process.

9. The method of claim 8, wherein the ROI comprises a face of the subject.

10. The method of claim 9, wherein performing the second AE process comprises determining a location of the face of the subject in the second sensor data.

11. The method of claim 8, wherein the second AE process further comprises a blending between a scene average AE process and the ROI-weighted AE process.

12. The method of claim 1, wherein the second sensor data comprises sensor data captured from at least a first image sensor and a second image sensor.

13. The method of claim 12, wherein the first image sensor and the second image sensor are driven with different exposure settings.

14. The method of claim 1, wherein the first sensor data and the second sensor data are captured with different frame rates.

15. The method of claim 1, wherein generating a graphical representation for the subject further comprises:
fusing at least two image frames captured as part of the second sensor data.

16. The method of claim 1, further comprising:
performing, in response to no face location data being detected for the subject in the second sensor data, a third AE process on the second sensor data that is different than the second AE process.

17. A non-transitory computer readable medium comprising computer readable code executable by one or more processors to:
capture, by a head-mounted display (HMD) device operating in a first mode, first sensor data;
perform a first autoexposure (AE) process on the first sensor data;
determine that the HMD is operating in a second mode that is different than the first mode;
capture, by the HMD operating in the second mode, second sensor data;
determine face location data for a subject detected in the second sensor data;
perform a second AE process on the second sensor data that is different than the first AE process, wherein the second AE process is based, at least in part, on the determined face location data; and
generate a graphical representation for the subject, based, at least in part, on the second sensor data that has had the second AE process performed on it.

18. The non-transitory computer readable medium of claim 17, wherein the first mode comprises a passthrough video generation mode, and wherein the second mode comprises an enrollment mode.

19. The non-transitory computer readable medium of claim 17, wherein the second AE process comprises a region of interest (ROI)-weighted AE process.

20. A head-mounted display (HMD) device, comprising:
one or more processors;
a display;
one or more image sensors; and
one or more computer readable media comprising computer readable code executable by the one or more processors to:
capture, by at least a first image sensor of the HMD operating in a first mode, first sensor data;
perform a first autoexposure (AE) process on the first sensor data;
determine that the HMD is operating in a second mode that is different than the first mode;
capture, by at least a first image sensor of the HMD operating in the second mode, second sensor data;
determine face location data for a subject detected in the second sensor data;
perform a second AE process on the second sensor data that is different than the first AE process, wherein the second AE process is based, at least in part, on the determined face location data; and
generate a graphical representation for the subject, based, at least in part, on the second sensor data that has had the second AE process performed on it.
